(19) United States
(12) Patent Application Publication
(10) Pub. No.: US 2024/0424709 A1
(43) Pub. Date: Dec. 26, 2024

(54) SYSTEMS AND METHODS FOR A BEAM CUTTING PROCESS FOR A WALL PANEL

(71) Applicant: Hercu Tech, Inc., Tempe, AZ (US)

(72) Inventor: Randall C. Hartwick, Tempe, AZ (US)

(73) Assignee: Hercu Tech, Inc., Tempe, AZ (US)

(21) Appl. No.: 18/742,465

(22) Filed: Jun. 13, 2024

Related U.S. Application Data
(60) Provisional application No. 63/510,032, filed on Jun. 23, 2023.

(51) Int. Cl. B26F 3/12; B26D 3/00; B26D 7/02

(52) U.S. Cl. CPC B26F 3/12; B26D 3/006; B26D 7/025

(57) ABSTRACT

A beam cutting system ensures horizontal and vertical alignment of a wall panel prior to cutting a standardized edge having a horizontal void along the wall panel. The beam cutting system includes a first harp assembly operable for cutting along a first path and a second harp assembly operable for cutting along a second path, where the first harp assembly and the second harp assembly are parallel with one another and operable for simultaneous but mirrored motion.

### FIELD

The present disclosure generally relates to construction material fabrication, and in particular, to a system and associated method for cutting EPS foam to create beam sections in stay-in-place concrete form wall panels.

### BACKGROUND

Advancements in expanded polystyrene (EPS) materials have enabled the use of EPS for fabricating stay-in-place, insulated concrete form wall panels. In particular, a wall panel made from EPS includes an upper horizontally-aligned void and a lower horizontally-aligned void for placement of a concrete material therein such that when the concrete material dries, the concrete material forms horizontal beams within the wall panel. For construction of a single wall, multiple panels can be connected together and aligned prior to pouring the concrete material.

It is necessary for each wall panel to be cut in a precise and accurate manner to prevent structural failure due to misalignment and non-uniformity between wall panels, especially the upper and lower horizontal voids of each wall panel. The process of cutting each individual wall panel can be time-consuming and prone to human error. As such, a process for rapidly cutting the upper and lower horizontal voids of each wall panel while maintaining uniformity and precision is desired.

It is with these observations in mind, among others, that various aspects of the present disclosure were conceived and developed.

### BRIEF DESCRIPTION OF THE DRAWINGS

FIG. 1A is a side view of a beam cutting system for cutting a wall panel;

FIG. 1B is a top view of the beam cutting system of FIG. 1A without an upper assembly;

FIG. 1C is a perspective view of the beam cutting system of FIG. 1B;

FIGS. 2A and 2B are a pair of respective illustrations showing the wall panel of FIG. 1A prior to and following cutting by the beam cutting system of FIG. 1A;

FIGS. 2C and 2D are a pair of respective illustrations showing a pathing for cutting a top portion and a bottom portion of a wall panel using the beam cutting system of FIG. 1A;

FIGS. 3A-3G are a series of illustrations showing a sequence for cutting the wall panel using the beam cutting system of FIG. 1A;

FIGS. 4A and 4B are a pair of respective illustrations showing a front view of a harp assembly of the beam cutting system of FIG. 1A operable for movement along a vertical axis;

FIGS. 4C and 4D are a pair of respective illustrations showing a side view of a first harp assembly and a second harp assembly of the beam cutting system of FIG. 1A operable for movement along a lateral axis;

FIG. 4E is an illustration showing an enlarged view of the harp assembly of the beam cutting system of FIG. 1A;

FIG. 5A is a side view of alignment assembly of the beam cutting system of FIG. 1A;

FIG. 5B is an enlarged view of a vertical alignment clamp assembly of the beam cutting system of FIG. 1A;

FIG. 5C is an enlarged view of a horizontal alignment gate of the beam cutting system of FIG. 1A;

FIG. 6 is a simplified block diagram showing an actuation system and a control system of the beam cutting system of FIG. 1A;

FIG. 7 is a simplified diagram showing an example computing device for implementation of the beam cutting system of FIG. 1A; and

FIGS. 8A-8D are a series of process flow charts showing an example method for cutting a wall panel according to the system of FIG. 1A.

Corresponding reference characters indicate corresponding elements among the view of the drawings. The headings used in the figures do not limit the scope of the claims.

### DETAILED DESCRIPTION

Various embodiments of a system and associated methods for uniformly cutting a wall panel are disclosed herein. In particular, a beam cutting system includes a vertical alignment clamp assembly and a horizontal alignment gate that align a wall panel prior to cutting a first standardized edge and a second standardized edge of the wall panel. The beam cutting system includes a first harp and a second harp that simultaneously cut the first standardized edge and the bottom edge of the wall panel in a mirrored pathing arrangement, where the first standardized edge includes a first horizontal void and where the second standardized edge includes a second horizontal void. The beam cutting system streamlines the cutting process to enable a manufacturer to rapidly produce many wall panels while maintaining uniformity. As used herein the term “harp” means a frame that holds and provides tension to a cutting element such as a hot wire.

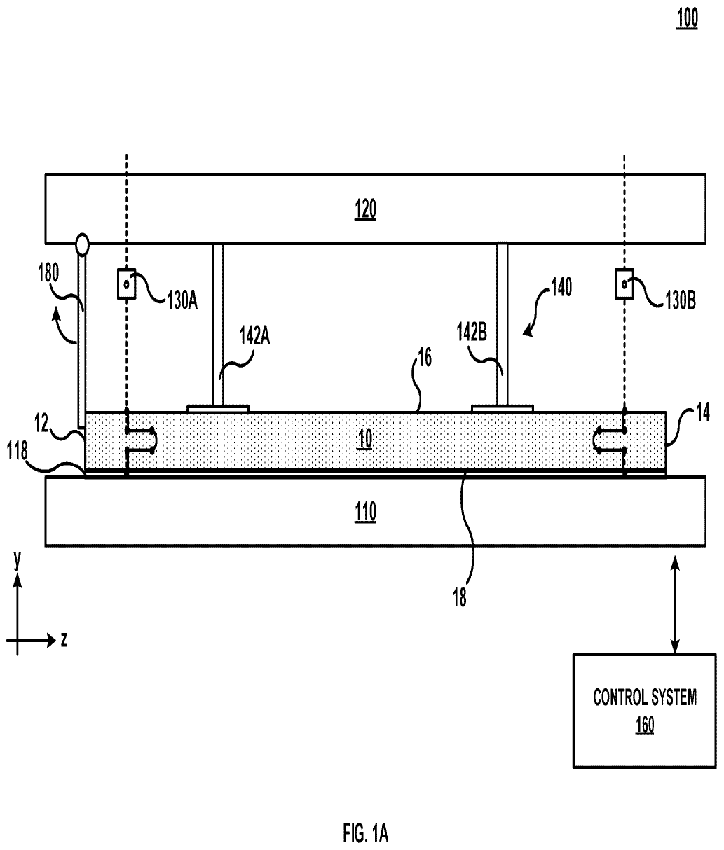

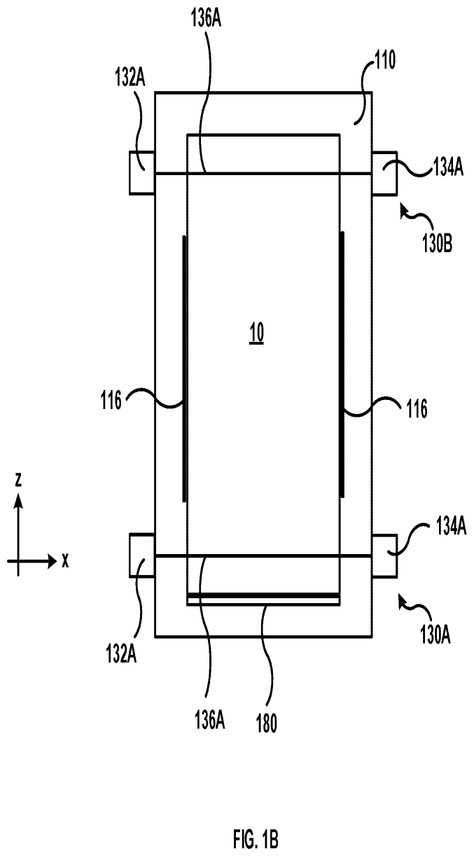

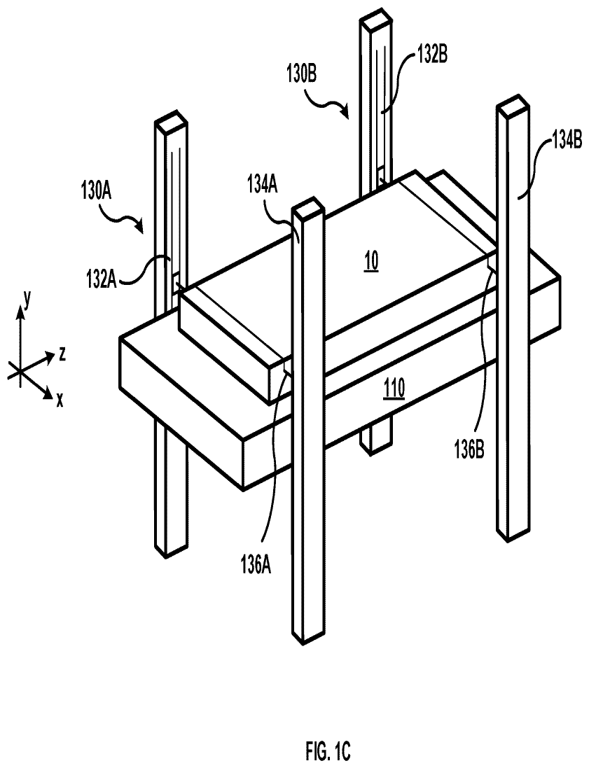

FIGS. 1A-1C illustrate a beam cutting system 100 according to aspects of the present disclosure in which the beam cutting system 100 includes a platform 110 for placement of a wall panel 10 for cutting. As shown, the wall panel 10 includes a first edge 12 (e.g., the bottom edge) and a second edge 14 (e.g., the top edge), where the first edge 12 and the second edge 14 are to be cut by the beam cutting system 100 such that a total height of the wall panel 10 confirms to a desired height following processing by the beam cutting system 100. The wall panel 10 includes a first face 16 and a second face 18; when positioned along the platform 110 of the beam cutting system 100, the first face 16 faces “upward” and the second face 18 faces “downward” such that the second face 18 contacts the platform 110. As shown, the beam cutting system 100 includes an upper assembly 120 having several alignment structures including a horizontal alignment gate 180 and a vertical alignment clamp assembly 140 to ensure horizontal and vertical alignment of the wall panel 10 prior to cutting such that wall panels 10 processed by the beam cutting system 100 are uniform and conform to design specifications provided by the manufacturer.

When the wall panel 10 is positioned along the platform 110 of the beam cutting system 100, the first edge 12 is aligned by abutting the first edge 12 against the horizontal alignment gate 180 as shown to ensure horizontal alignment of the wall panel 10. In some embodiments, the beam cutting system 100 further includes horizontal alignment structures 116 positioned along the platform 110 that further ensure alignment of the wall panel 10 in the horizontal plane (e.g., the “x-z” plane as shown in FIG. 1B; note that these horizontal alignment structures 116 should not intrude into the cutting path of the beam cutting system 100 described in further detail below. The vertical alignment clamp assembly 140 includes a plurality of vertical alignment clamps 142 (shown in FIG. 1A as a first vertical alignment clamp 142A and a second vertical alignment clamp 142B) that extend downward and contact the first face 16 of the wall panel 10 as shown to ensure vertical alignment of the wall panel 10 prior to processing.

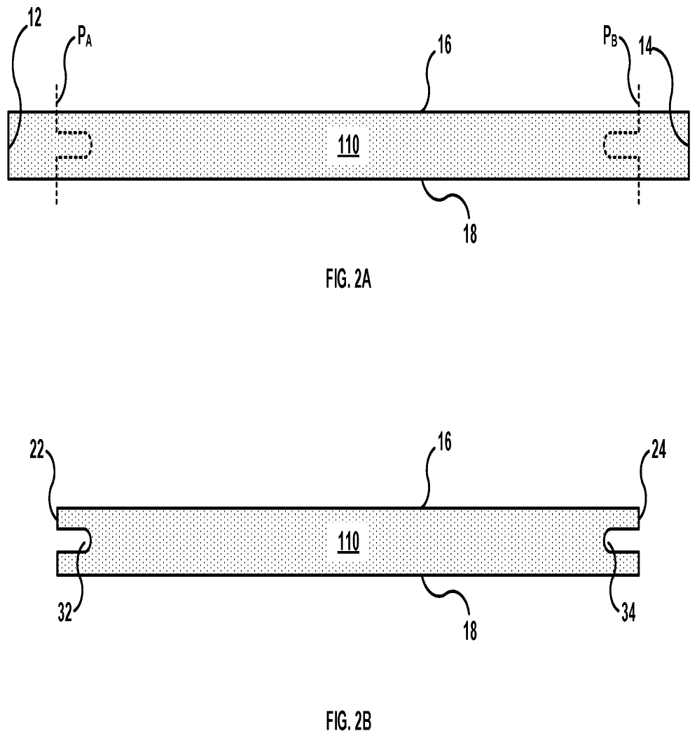

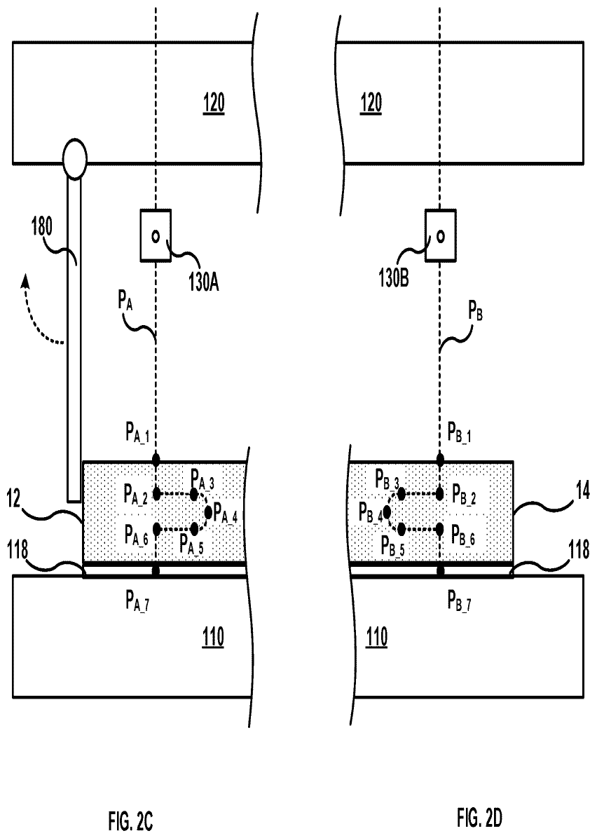

As shown, the beam cutting system 100 further includes a first harp assembly 130A and a second harp assembly 130B that collectively enable the beam cutting system 100 to simultaneously cut a first standardized edge 22 having a first horizontal void 32 (FIG. 2D) along the first edge 12 of the wall panel 10 and a second standardized edge 24 having a second horizontal void 34 (FIG. 2D) along the second edge 14 of the wall panel 10, where a first path followed by the first harp assembly 130A and a second path followed by the second harp assembly 130B are mirrored relative to one another. FIG. 1C provides a perspective view of the beam cutting system 100 with the upper assembly 120 and alignment structures removed to show the first harp assembly 130A and the second harp assembly 130B. In some embodiments, the first harp assembly 130A includes a first prong 132A and a second prong 134A, with a first cutting element 136A therebetween (e.g., stretching along the “x” axis); similarly, the second harp assembly 130B includes a first prong 132B and a second prong 134B, with a second cutting element 136B therebetween. In the example shown, the cutting elements 136A and 136B are each a wire (e.g., a “hot wire”), however, note that other configurations featuring alternate cutting elements are contemplated. As shown, the first cutting element 136A of the first harp assembly 130A and the second cutting element 136B of the second harp assembly 130B are oriented parallel with one another and are operable for independent movement.

The beam cutting system 100 can be electronically controlled by a control system 160 in electrical communication with various components of the beam cutting system 100, including the first harp assembly 130A, the second harp assembly 130B, the horizontal alignment gate 180 (FIG. 2C) and the vertical alignment clamp assembly 140. In some embodiments, the control system 160 can accept a computer-encoded pathing for the first harp assembly 130A and the second harp assembly 130B as shown in FIG. 1A, where the computer-encoded pathing is modeled in a planning environment and converted into machine-readable code that controls mechanical components of the beam cutting system 100 to execute the cutting sequence.

FIGS. 2A and 2B respectively illustrate the wall panel 10 before and after processing by the beam cutting system 100 of FIGS. 1A-1C. In FIG. 2A, the wall panel 10 includes the first edge 12 and the second edge 14. In FIG. 2B, the first edge 12 has been cut along a first path P_{A} yielding the first standardized edge 22 having the first horizontal void 32 and the second edge 14 has been cut along a second path P_{B} to yielding the second standardized edge 24 having the second horizontal void 34; note that the first path P_{A} and the second path P_{B} are mirrored. FIGS. 2C and 2D show mirrored paths followed by the first harp assembly 130A and the second harp assembly 130B of the beam cutting system 100.

As shown in FIG. 2C, the first harp assembly 130A follows a first path P_{A} to cut the first standardized edge 22 including the first horizontal void 32 along the first edge 12 of the wall panel 10. As shown, the first path P_{A} includes a first point P_{A_1} where the first harp assembly 130A meets the wall panel 10 and continues moving in a first downward direction to cut a first segment of the first path P_{A}, a second point P_{A_2} within the wall panel 10 where the first harp assembly 130A changes direction and starts to move in a first lateral direction to cut a second segment of the first path P_{A} and a third point P_{A_3} within the wall panel 10 where the first harp assembly 130A changes direction and starts to move in both the first downward direction and the first lateral direction to cut a third segment, which is a first half of a first curve of the first path P_{A}. The first half of the first curve of the first path P_{A} terminates at a fourth point P_{A_4} within the wall panel 10, at which the first harp assembly 130A changes direction and starts to move in a second lateral direction and the first downward direction to cut a fourth segment, which is a second half of the first curve of the first path P_{A}. The second half of the first curve of the first path P_{A} terminates at a fifth point P_{A_5} within the wall panel 10, at which the first harp assembly 130A changes direction and starts to move in the first lateral direction again to cut a fifth segment of the first path P_{A}. The fifth segment of the first path P_{A} terminates at a sixth point P_{A_6} at which the first harp assembly 130A starts to move in the first downward direction again to cut a sixth segment which terminates at a seventh point P_{A_7} at which the first harp assembly 130A has completed cutting along the first path P_{A} of the wall panel 10. As shown, the platform 110 can include a sacrificial foam piece 118 positioned underneath the wall panel 10 that allows the first harp assembly 130A to cut clean through the wall panel 10 without contacting the platform 110. Following the seventh point P_{A_7}, the first harp assembly 130A is actuated in a second upward direction to return the first harp assembly 130A to its original position above the wall panel 10 for processing of another wall panel.

As shown in FIG. 2D, the second harp assembly 130B follows a second path P_{B} to cut the second standardized edge 24 including the second horizontal void 34 along the second edge 14 of the wall panel 10. Note that the second harp assembly 130B cuts the second path P_{B} simultaneously while the first harp assembly 130A cuts the first path P_{A}, and that the second path P_{B} is mirrored relative to the first path P_{A}.

As shown, the second path P_{B} includes a first point P_{B_1} where the second harp assembly 130B meets the wall panel 10 and continues moving in the first downward direction to cut a first segment of the second path P_{B}, a second point P_{B_2} within the wall panel 10 where the second harp assembly 130B changes direction and starts to move in the second lateral direction to cut a second segment of the second path P_{B} and a third point P_{B_3} within the wall panel 10 where the second harp assembly 130B changes direction and starts to move in both the first downward direction and second lateral direction to cut a third segment, which is a first half of a second curve of the second path P_{B}. The first half of the second curve of the second path P_{B} terminates at a fourth point P_{B_4} within the wall panel 10, at which the second harp assembly 130B changes direction and starts to move in the first lateral direction and the first downward direction to cut a fourth segment, which is a second half of the second curve of the second path P_{B}. The second half of the second curve of the second path P_{B} terminates at a fifth point P_{B_5} within the wall panel 10, at which the second harp assembly 130B changes direction and starts to move in the second lateral direction again to cut a fifth segment of the second path P_{B}. The fifth segment of the second path P_{B} terminates at a sixth point P_{B_6} at which the second harp assembly 130B starts to move in the first downward direction again to cut a sixth segment which terminates at a seventh point P_{B_7} at which the second harp assembly 130B has completed cutting along the second path P_{B} of the wall panel 10. As shown, the platform 110 can include the sacrificial foam piece 118 positioned underneath the wall panel 10 that allows the second harp assembly 130B to cut clean through the wall panel 10 without contacting the platform 110. Following the seventh point P_{B_7}, the second harp assembly 130B is actuated in the second upward direction to return the second harp assembly 130B to its original position above the wall panel 10 for processing of another wall panel.

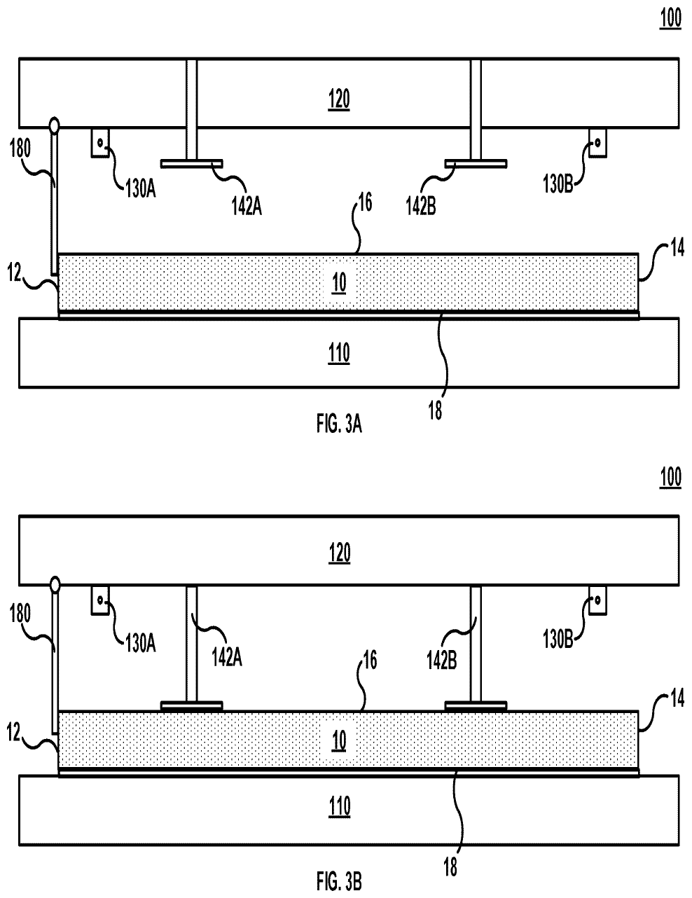

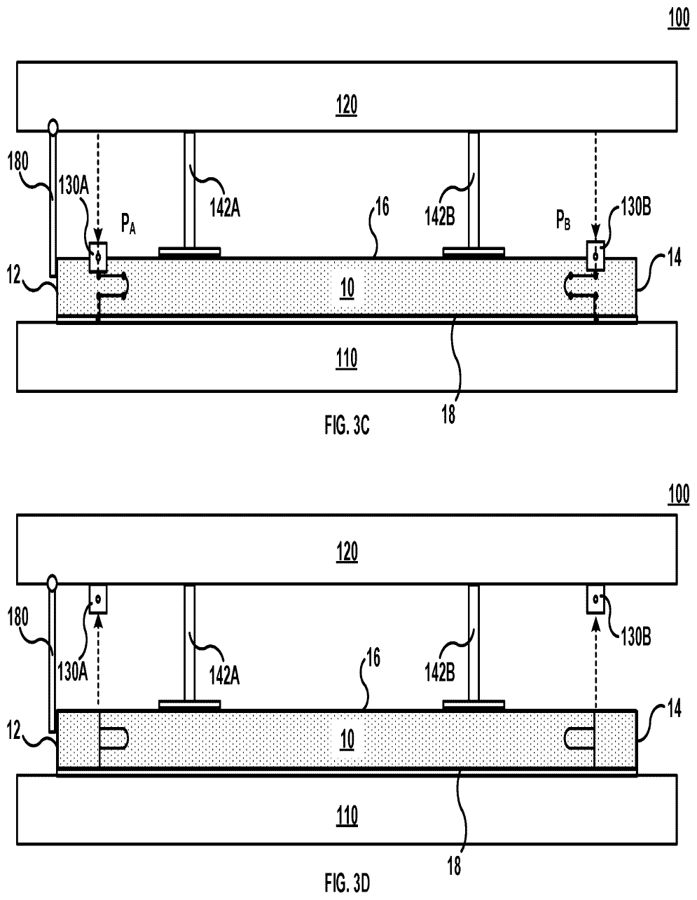

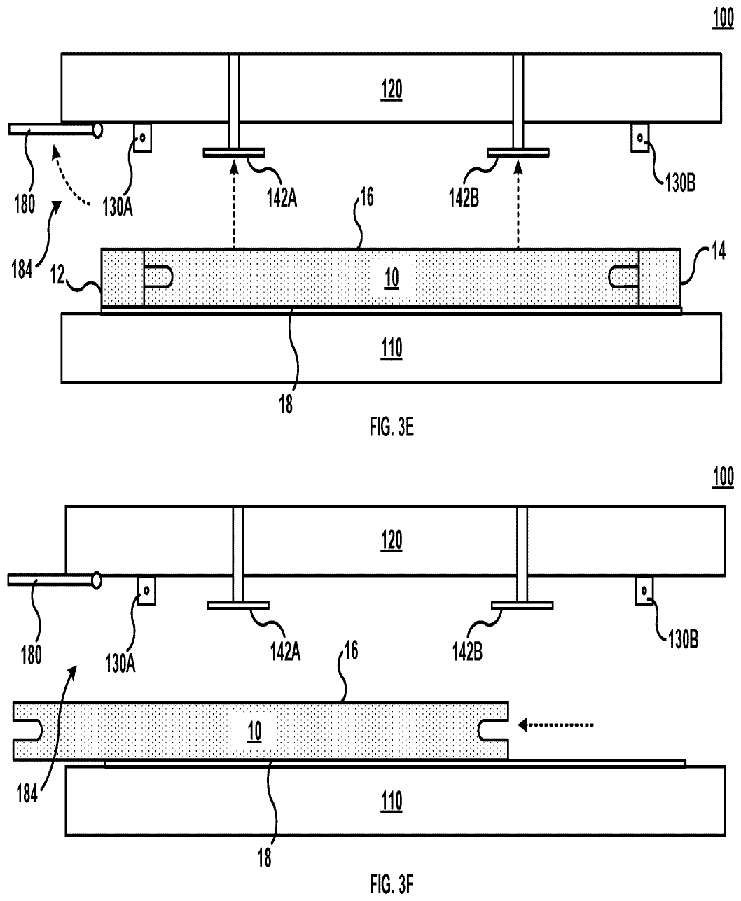

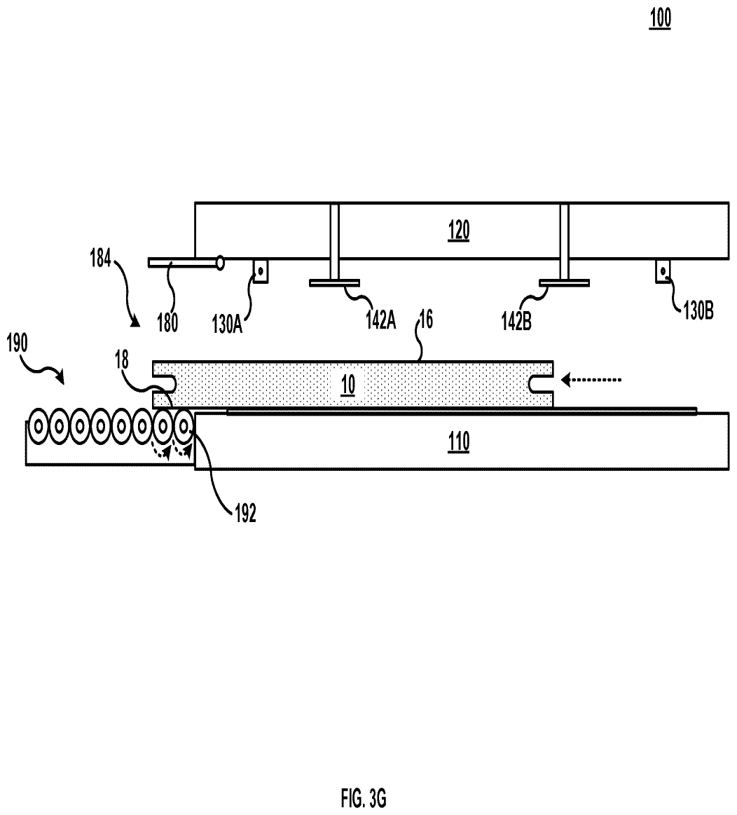

FIGS. 3A-3G illustrate a process for cutting the wall panel 10 by the beam cutting system 100 of FIGS. 1A-2D. As shown in FIG. 3A, the wall panel 10 is positioned along the platform 110 of the beam cutting system 100 such that the second face 18 of the wall panel 10 contacts the platform 110 and the first edge 12 abuts against the horizontal alignment gate 180. Note that in FIG. 3A, the horizontal alignment gate 180 is shown in a first “downward” position that extends from the upper assembly 120 and aligns the wall panel 10 in the horizontal plane (e.g., the “x-z” plane) to ensure uniformity. Also note that in FIG. 3A, the first vertical alignment clamp 142A and the second vertical alignment clamp 142B of the vertical alignment clamp assembly 140 are positioned above the first face 16 of the wall panel 10 but are not yet in contact with the first face 16 to allow re-positioning of the wall panel 10 relative to the horizontal alignment gate 180. Further, as shown, the first harp assembly 130A is at an initial position above the wall panel 10 and the second harp assembly 130B is similarly at an initial position above the wall panel 10.

Once the wall panel 10 is properly aligned in the horizontal plane by the horizontal alignment gate 180, in FIG. 3B, the first vertical alignment clamp 142A and the second vertical alignment clamp 142B of the vertical alignment clamp assembly 140 are actuated downward towards the platform 110 such that they contact the first face 16 of the wall panel 10. The vertical alignment clamp assembly 140 immobilizes the wall panel 10 and provides slight compression to ensure that the wall panel 10 is aligned in the vertical plane. Due to the lightweight and nature of EPS material, this step is important as it prevents misalignment of the wall panel 10 during the cutting procedure and ensures that wall panels 10 produced in the same manner are uniform.

With reference to FIG. 3C, once the wall panel 10 is aligned in both the horizontal plane and the vertical plane and immobilized, the first harp assembly 130A and the second harp assembly 130B are simultaneously actuated in the downward direction towards the platform 110 to begin the cutting sequence described above with reference to FIGS. 2A-2D. The first harp assembly 130A cuts into the wall panel 10 along the first path P_{A} and the second harp assembly 130B cuts into the wall panel 10 along the second path P_{B}, where the first path P_{A} and the second path P_{B} are mirrored relative to one another and where the first harp assembly 130A and the second harp assembly 130B each cut their respective first and second paths P_{A} and P_{B} simultaneously.

As shown in FIG. 3D, once the cutting sequence of FIGS. 2A-2D is complete, the first harp assembly 130A and the second harp assembly 130B are simultaneously actuated in the upward direction away from the platform 110 back to their initial positions shown in FIG. 3A. The wall panel 10 should now exhibit the first standardized edge 22 including the first horizontal void 32 and the second standardized edge 24 including the second horizontal void 34 as shown.

FIGS. 3E and 3F show ejection of the wall panel 10 from the beam cutting system 100 after the cutting sequence is complete and the first harp assembly 130A and the second harp assembly 130B have returned to their initial positions. In particular, as illustrated in FIG. 3E, the horizontal alignment gate 180 is “lifted” away from the wall panel 10 to a second “upward” position and the first vertical alignment clamp 142A and the second vertical alignment clamp 142B of the vertical alignment clamp assembly 140 are brought back upward towards the upper assembly 120 and away from the wall panel 10. As shown in FIGS. 3F and 3G, the superfluous material from the wall panel 10 can be removed and the wall panel 10 can be pushed off from the platform 110 and removed from the beam cutting system 100 through an exit void 184 opened by the horizontal alignment gate 180 as shown. Further, in some embodiments shown in FIG. 3G, the beam cutting system 100 can include a roller assembly 190 featuring a plurality of passive rollers 192 positioned adjacent to the platform 110 that enable the wall panel 10 to slide in the second lateral direction off from the platform 110. In the embodiment of FIG. 3G, the roller assembly 190 is positioned near the exit void 184, although note that another roller assembly 190 can be positioned adjacent to the opposite side of the platform 110 to enable the wall panel 10 to slide onto the platform 110 prior to processing.

The cycle can then be repeated beginning with the configuration of FIG. 3A in which the horizontal alignment gate 180 is dropped back down to the first “downward” position for receipt and alignment of another wall panel.

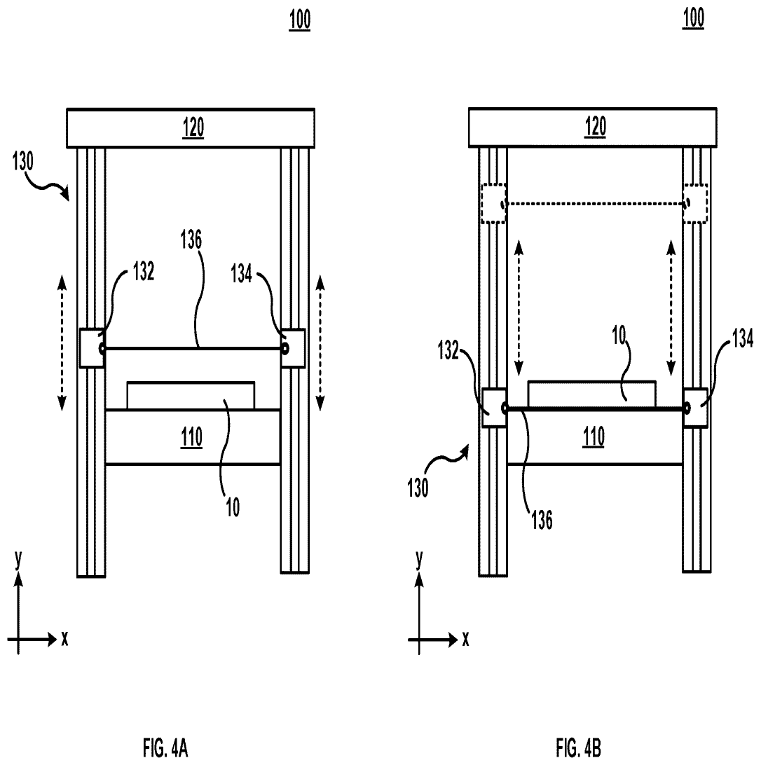

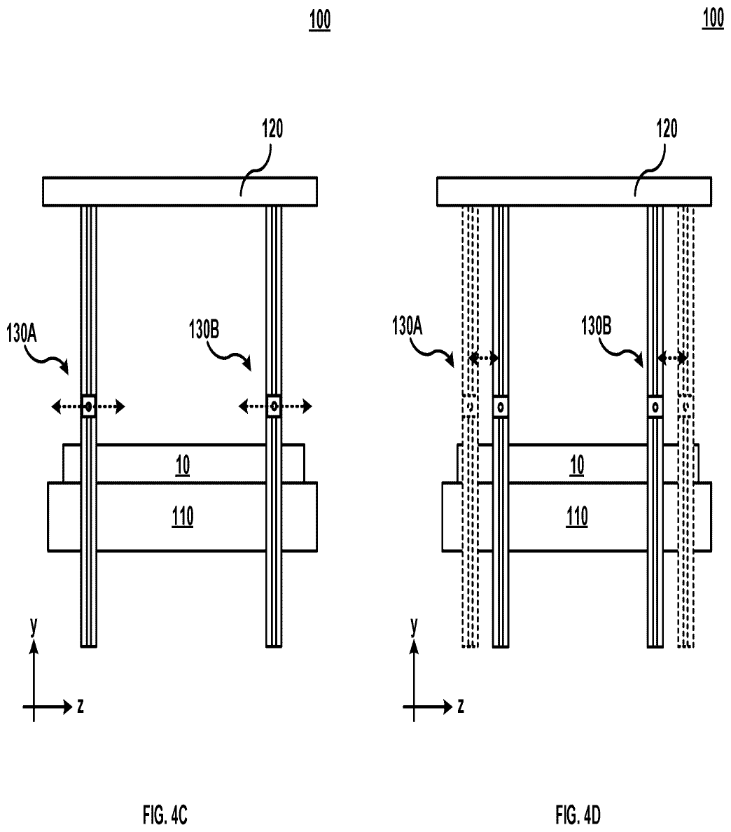

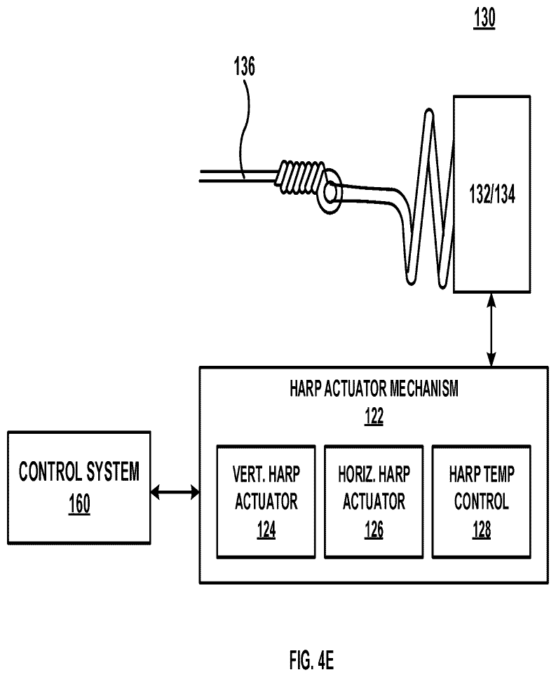

Referring to FIGS. 4A-4E, the first harp assembly 130A and the second harp assembly 130B are moveable along a vertical axis (e.g., the “y” axis) and a lateral axis (e.g., the “z” axis). In particular, FIGS. 4A and 4B illustrate vertical movement of the first harp assembly 130A and the second harp assembly 130B (shown generically in FIGS. 4A, 4B and 4E as harp assembly 130). As shown, the harp assembly 130 including the first prong 132, the second prong 134, and the cutting element 136 are moveable together in the first downward direction and the second upward direction along a vertical axis (e.g., the “y” axis). FIG. 4B shows the harp assembly 130 positioned at a first “default” position above the wall panel 10 (shown in phantom) and moveable to a second “cutting position” near the platform 110 where the harp assembly 130 cuts into the wall panel 10. While in the second “cutting” position, the harp assembly 130 can move along the vertical axis to cut along the first path P_{A} and the second path P_{B} as discussed above with reference to FIGS. 2A and 2B.

FIGS. 4C and 4D illustrate lateral movement of the first harp assembly 130A and the second harp assembly 130B along the lateral axis (e.g., the “z” axis). In particular, FIG. 4D shows the first harp assembly 130A and the second harp assembly 130B each positioned at a first lateral position along the wall panel 10 (shown in phantom) and a second lateral position along the wall panel 10. While positioned along the first lateral position, the first harp assembly 130A and the second harp assembly 130B can cut along the first path P_{A} from points P_{A_1} to P_{A_2} (FIG. 2A) and along the second path P_{B} from points P_{B_1} to P_{B_2} (FIG. 2B). When moving towards the second lateral position, the first harp assembly 130A and the second harp assembly 130B can cut along the first path P_{A} from points P_{A_2} to P_{A_3} to P_{A_4} and along the second path P_{B} from points P_{B_2} to P_{B_3} to P_{B_4}. Note that the path between points P_{A_3} and P_{A_4} as well as the path between P_{B_3} and P_{B_4} are curved, requiring the first harp assembly 130A and the second harp assembly 130B to reverse lateral direction in the middle of the curve while continuing to move downward along the vertical axis to cut along the first path P_{A} from points P_{A_4} to P_{A_5} and along the second path P_{B} from points P_{B_4} to P_{B_5}. Similarly, when moving from the second lateral position towards the first lateral position, the first harp assembly 130A and the second harp assembly 130B can cut along the first path P_{A} from points P_{A_5} to P_{A_6} and along the second path P_{B} from points P_{B_5} to P_{B_6}.

In a primary embodiment, the first harp assembly 130A and/or the second harp assembly 130B are moveable along the entire lateral length of the platform 110 (e.g., the “z” axis) to accommodate different “target” heights of wall panels 10. For instance, for a wall panel 10 that needs to be eight feet tall, a separation length between the first lateral position of the first harp assembly 130A and the first lateral position of the second harp assembly 130B must be eight feet. For a wall panel 10 that needs to have a top horizontal void and a bottom horizontal void that are six inches deep, a separation length between the first lateral position and the second lateral position of the first harp assembly 130A needs to be six inches and a separation length between the first lateral position and the second lateral position of the second harp assembly 130B needs to be six inches.

FIG. 4E shows a simplified view of the harp assembly 130 (which can be the first harp assembly 130A or the second harp assembly 130B) including the first prong 132 and/or the second prong 134, with the cutting element 136 coupled along the first prong 132 and/or the second prong 134. As shown, the first prong 132 and/or the second prong 134 are movable by a harp actuator mechanism 122, which can include a vertical harp actuator 124 for actuating the harp assembly 130 along the vertical axis (e.g., the “y” axis) as shown in FIGS. 4A and 4B and a horizontal harp actuator 126 for actuating the harp assembly 130 along the lateral axis (e.g., the “z” axis) as shown in FIGS. 4C and 4D. In some embodiments, the vertical harp actuator 124 can include a lead screw (not shown) that lifts the harp assembly 130 away from the platform 110 when rotated in a first direction and lowers the harp assembly 130 towards the platform 110 when rotated in a second direction. The horizontal harp actuator 126 can include a linear actuator that moves the first harp assembly 130A or the second harp assembly 130B to the intended first lateral position and the intended section lateral position considering proper separation length between the first lateral position of the first harp assembly 130A and the first lateral position of the second harp assembly 130B. In some embodiments, the vertical harp actuator 124 and the horizontal harp actuator 126 each receive control signals from the control system 160 to enable the first harp assembly 130A and the second harp assembly 130B to cut along the first path P_{A} and the second path P_{B}. Further, the harp actuator mechanism 122 can include a harp temperature control module 128 that monitors and controls a temperature of the cutting element 136 in response to control signals from the control system 160; if the cutting element 136 is a hot wire, then the harp temperature control module 128 applies a current through the cutting element 136 to heat the cutting element 136 to a suitable temperature for cutting EPS material. Typically, the cutting element 136 should exhibit a dull red color when heated.

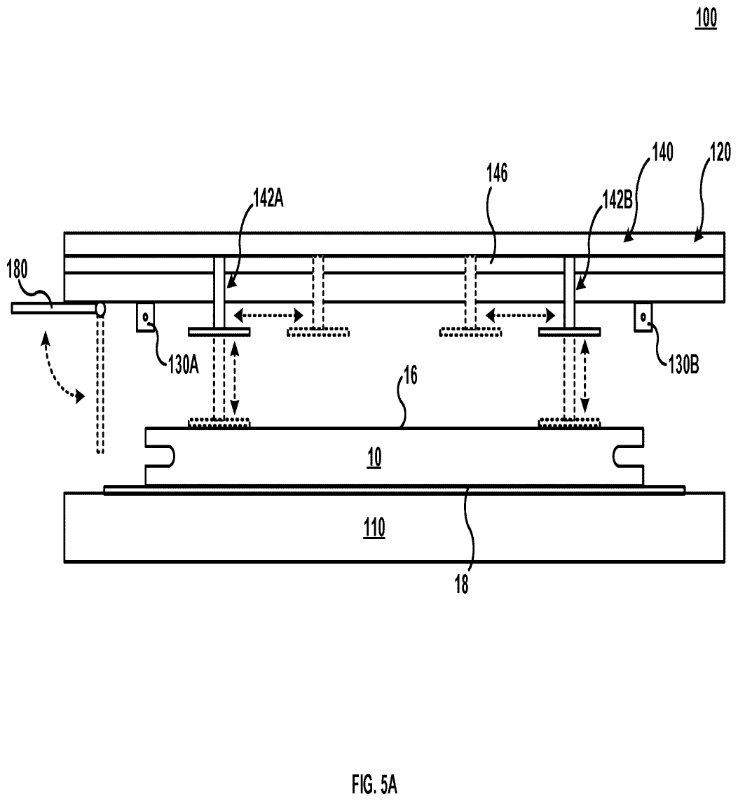

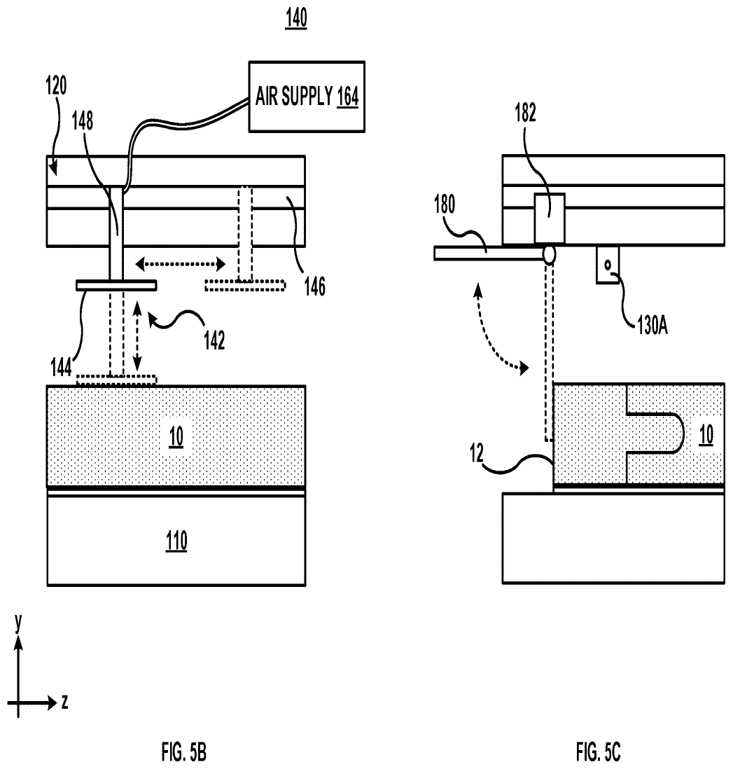

FIGS. 5A-5C show example movement ranges for various alignment structures of the beam cutting system 100. In particular, FIG. 5A shows lateral and vertical translation of the vertical alignment clamp assembly 140 (including the first vertical alignment clamp 142A and the second vertical alignment clamp 142B, although note that the vertical alignment clamp assembly 140 can include any suitable quantity of vertical alignment clamps 142), and also shows actuation of the horizontal alignment gate 180 between the first “downward” position in which the horizontal alignment gate 180 aligns the wall panel 10 in the horizontal plane and the second “upward” position in which the horizontal alignment gate 180 disengages from the wall panel 10 and leaves the exit void 184 through which the wall panel 10 can be removed.

FIG. 5B focuses on the vertical alignment clamp assembly 140; as shown, the vertical alignment clamp 142 can be actuated downward along the vertical axis (e.g., the “y” axis) such that the vertical alignment clamp 142 contacts the wall panel 10, and can be actuated upward along the vertical axis to release the wall panel 10. As shown, the vertical alignment clamp 142 includes a planar clamp element 144 that contacts the wall panel 10; the planar clamp element 144 needs to be wide enough in diameter such that any downward force inadvertently or intentionally applied at the wall panel 10 is distributed along the wall panel 10 such that the planar clamp element 144 does not leave an impression on the wall panel 10. As shown, in some embodiments the vertical alignment clamp 142 includes a pneumatic actuator 148 that lifts and/or lowers the planar clamp element 144 as needed; the pneumatic actuator 148 can be actuated by an air supply 164 and can be controlled through control signals applied by the control system 160. Further, the vertical alignment clamp 142 is operable for active or passive lateral motion along a positioning rail 146; an operator can manually “nudge” the vertical alignment clamp 142 along the positioning rail 146 to a desired lateral position in the horizontal plane (e.g., along the “x” axis and/or the “z” axis) prior to “dropping” the vertical alignment clamp 142 onto the wall panel 10.

FIG. 5C shows actuation of the horizontal alignment gate 180 between the first “downward” and the second “upward” position. As shown, the horizontal alignment gate 180 can be actuated by a horizontal alignment gate actuator that actuates the horizontal alignment gate 180 between the first “downward” and the second “upward” position in response to control signals applied by the control system 160.

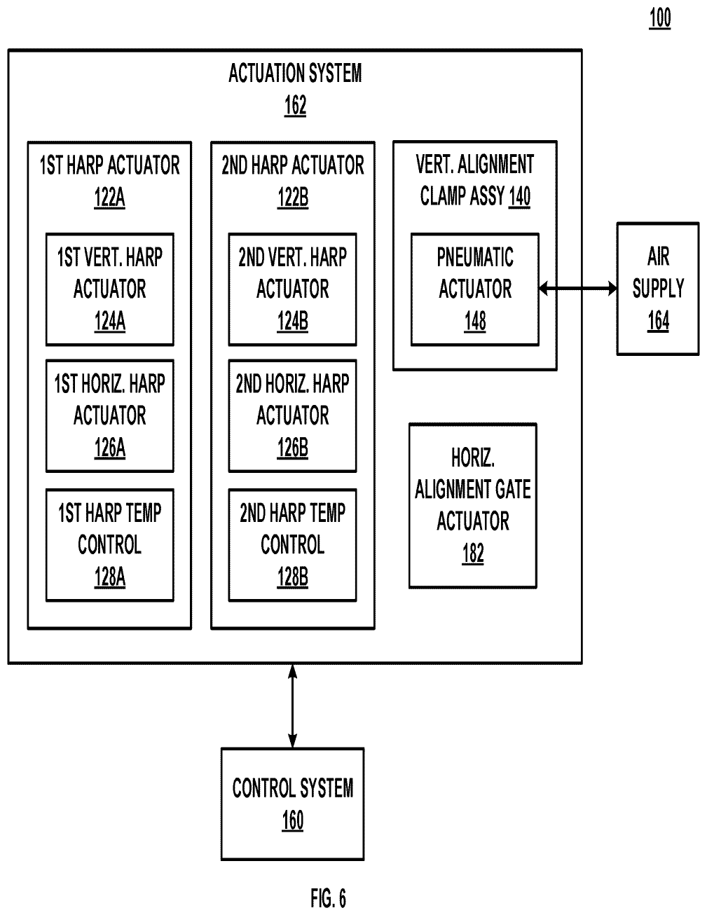

As shown in FIG. 6, the beam cutting system 100 includes an actuation system 162 in communication with the control system 160 that enable active motion of various components of the beam cutting system 100 as described above with reference to FIGS. 4A-5C. The actuation system 162 receives control signals from the control system 160 and actuates the first harp assembly 130A, the second harp assembly 130B, the vertical alignment clamp assembly 140 and the horizontal alignment gate actuator 182 accordingly.

The first harp assembly 130A is actuated along the lateral axis (e.g., the “z” axis) and the vertical axis (e.g., the “y” axis) by a first harp actuator mechanism 122A (discussed above with reference to FIG. 4E as harp actuator mechanism 122) in response to control signals from the control system 160. The first harp assembly 130A can include a first vertical harp actuator 124A (discussed above with reference to FIG. 4E as vertical harp actuator 124) for actuating the first harp assembly 130A along the vertical axis as shown in FIGS. 4A and 4B and a first horizontal harp actuator 126A for actuating the first harp assembly 130A along the lateral axis (e.g., the “z” axis) as shown in FIGS. 4C and 4D. Further, the first harp actuator mechanism 122A can include a first harp temperature control module 128A (discussed above with reference to FIG. 4E as harp temperature control module 128) for monitoring and controlling the temperature of the first cutting element 136A.

Similarly, the second harp assembly 130B is actuated along the lateral axis (e.g., the “z” axis) and the vertical axis (e.g., the “y” axis) by a second harp actuator mechanism 122B (discussed above as harp actuator mechanism 122) in response to control signals from the control system 160. The second harp assembly 130B can include a second vertical harp actuator 124B (discussed above as vertical harp actuator 124) for actuating the second harp assembly 130B along the vertical axis as shown in FIGS. 4A and 4B and a second horizontal harp actuator 126B for actuating the second harp assembly 130B along the lateral axis (e.g., the “z” axis) as shown in FIGS. 4C and 4D. Further, the second harp actuator mechanism 122B can include a second harp temperature control module 128B (discussed above as harp temperature control module 128) for monitoring and controlling the temperature of the second cutting element 136B.

The actuation system 162 also includes the pneumatic actuator 148 that actuates the vertical alignment clamp 142 of the vertical alignment clamp assembly 140 in response to control signals from the control system 160; the pneumatic actuator 148 moves the vertical alignment clamp 142 along the vertical direction (e.g., the “y” axis) discussed above with reference to FIGS. 5A and 5B. The pneumatic actuator 148 operates in fluid flow communication with the air supply 164 that provides pressurized air necessary to actuate the vertical alignment clamp 142 along the vertical direction. Further, the actuation system 162 includes the horizontal alignment gate actuator 182 that enables the horizontal alignment gate 180 to assume the first “downward” position of FIGS. 3A and 5C and to assume the second “upward” position of FIGS. 3F and 5C in response to control signals from the control system 160.

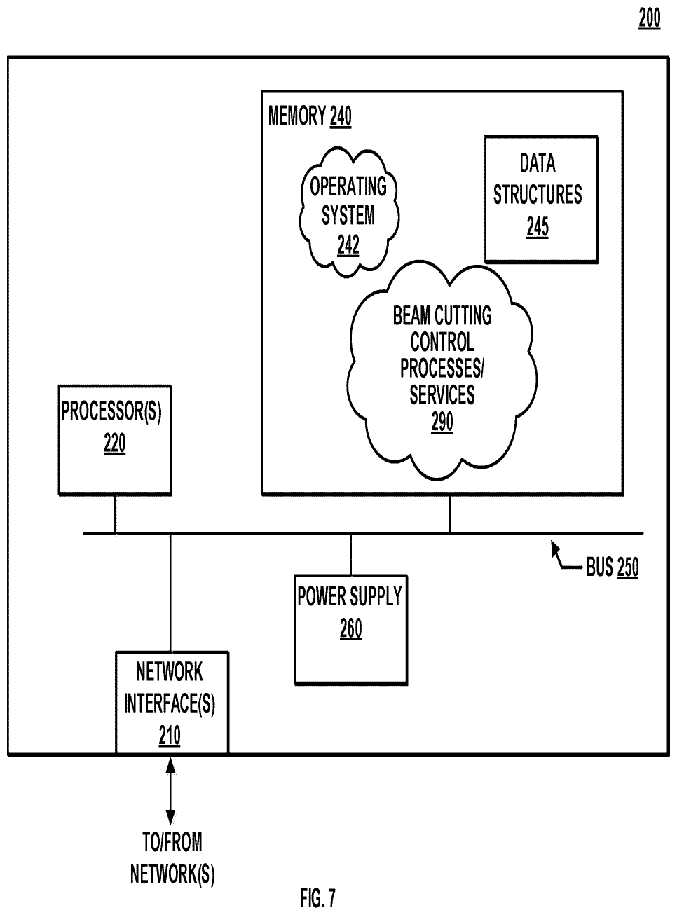

In some embodiments, the control system 160 communicates with a device 200 (FIG. 7) that dictates operation of the beam cutting system 100. In some embodiments, the device 200 can receive input parameters such as wall panel height and void depth values, and can communicate with the control system 160 to configure the actuation system 162 of the beam cutting system 100 according to the input parameters. In some embodiments, the input parameters can be input using a visual modeling program and communicated to the control system 160. In some embodiments, the control system 160 can include the device 200 for execution of various methods described herein.

### Computer-Implemented System

FIG. 7 is a schematic block diagram of an example device 200 that may be used with one or more embodiments described herein, e.g., as a component of beam cutting system 100 (as control system 160) shown in FIGS. 1A-6.

Device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

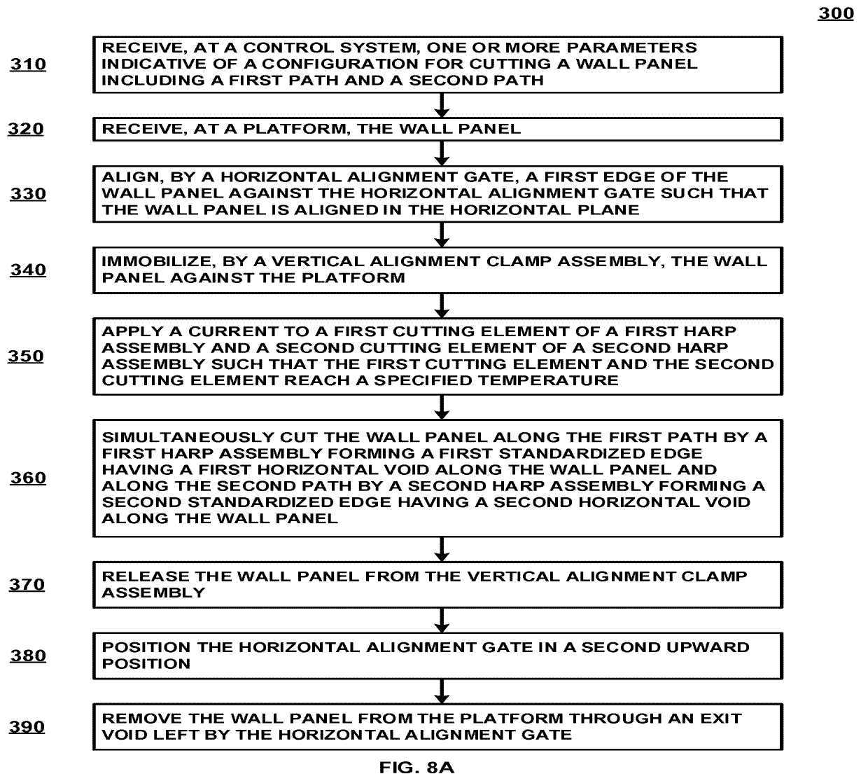

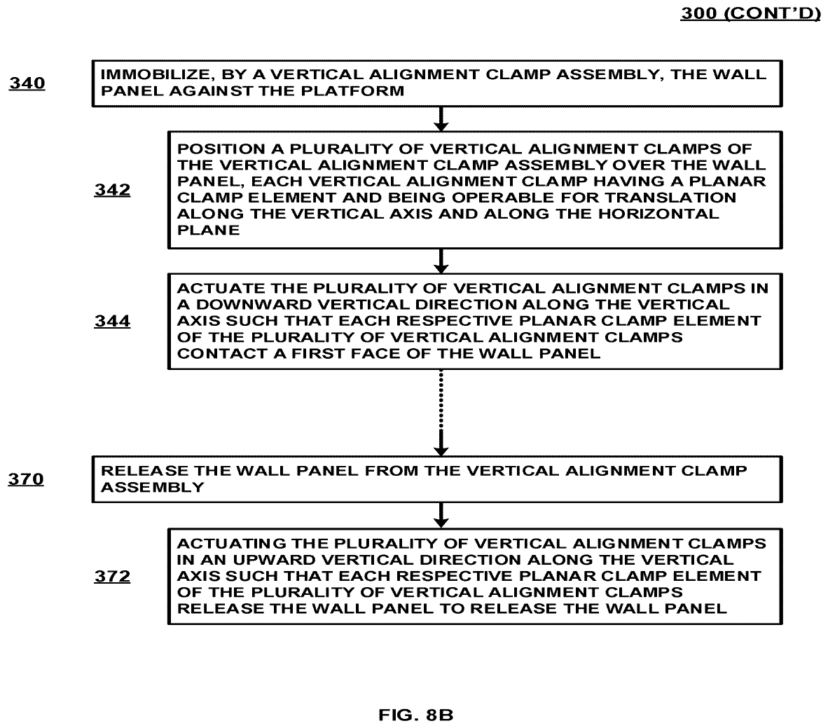

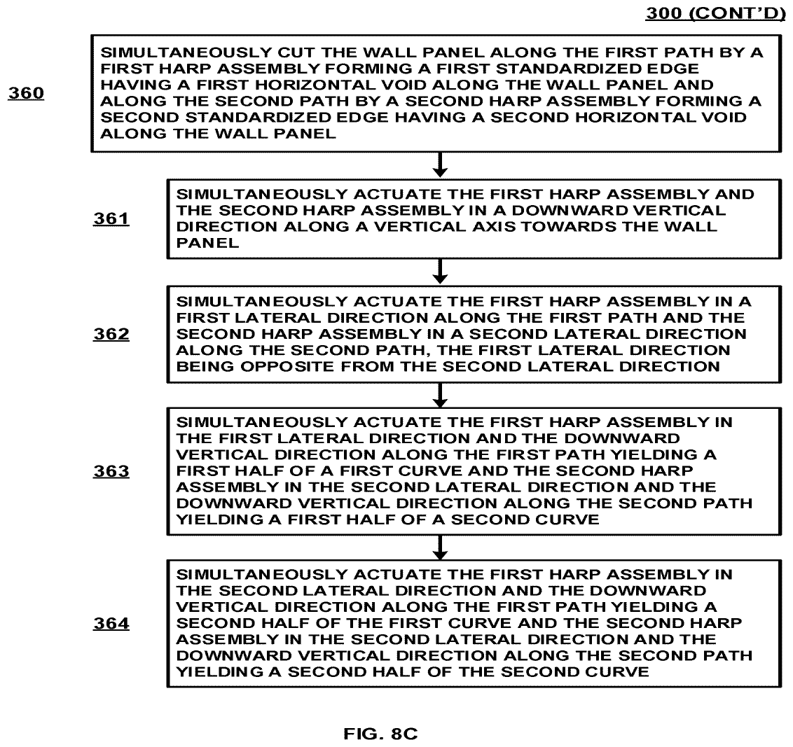

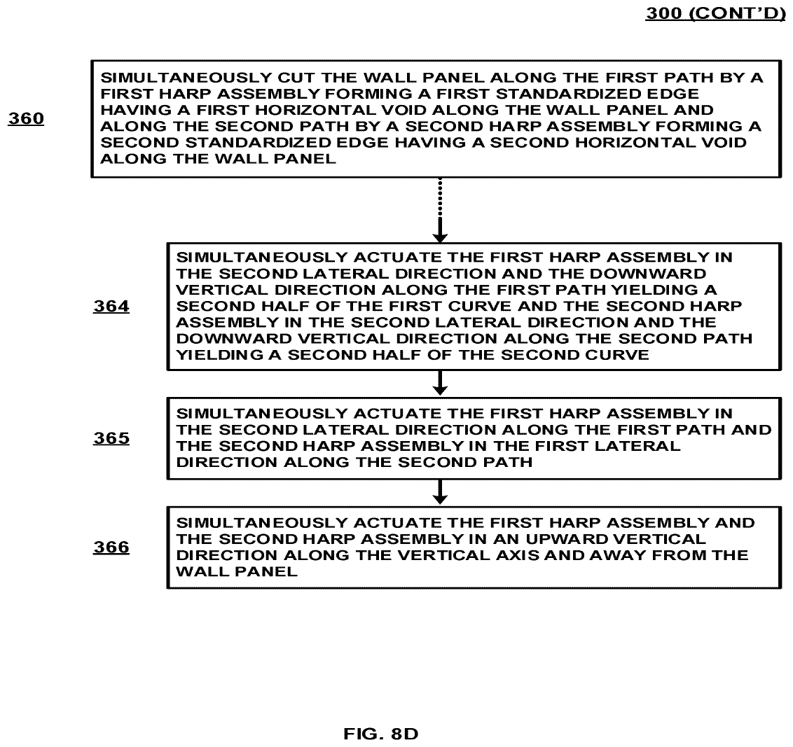

Memory 240 includes a plurality of storage locations that are addressable by processor 220 and network interfaces 210 for storing software programs and data structures associated with the embodiments described herein. In some embodiments, device 200 may have limited memory or no memory (e.g., no memory for storage other than for programs/processes operating on the device and associated caches). Memory 240 can include instructions executable by the processor 220 that, when executed by the processor 220, cause the processor 220 to implement aspects of the beam cutting system 100 and a method 300 (FIGS. 8A-8D) outlined herein.

Processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include beam cutting control processes/services 290, which can include aspects of method 300. Note that while beam cutting control processes/services 290 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the beam cutting control processes/services 290 is shown as a standalone process, those skilled in the art will appreciate that this process may be executed as a routine or module within other processes.

### Method

FIGS. 8A-8D illustrate a method 300 for cutting a wall panel by the beam cutting system 100 described herein.

Method 300 starts at block 310, which includes receiving, at a control system of the beam cutting system, one or more parameters indicative of a configuration for cutting a wall panel including a first path and a second path. Block 320 includes receiving, at a platform of the beam cutting system, the wall panel, where the wall panel includes a first edge and a second edge defined opposite to the first edge. Block 330 includes aligning, by a horizontal alignment gate of the beam cutting system, the first edge of the wall panel against the horizontal alignment gate such that the wall panel is aligned in the horizontal plane.

Block 340 includes immobilizing, by a vertical alignment clamp assembly, the wall panel against the platform, and can include various sub-steps including those outlined in blocks 342 and block 344. Block 342 includes positioning a plurality of vertical alignment clamps of the vertical alignment clamp assembly over the wall panel, each vertical alignment clamp having a planar clamp element and being operable for translation along the vertical axis and along the horizontal plane. Block 344 includes actuating the plurality of vertical alignment clamps in a downward vertical direction along the vertical axis such that each respective planar clamp element of the plurality of vertical alignment clamps contact a first face of the wall panel.

Block 350 includes applying a current to a first cutting element of a first harp assembly and a second cutting element of a second harp assembly such that the first cutting element and the second cutting element reach a specified temperature.

Block 360 includes simultaneously cutting the wall panel along the first path by a first harp assembly forming a first standardized edge having a first horizontal void along the wall panel and along the second path by a second harp assembly forming a second standardized edge having a second horizontal void along the wall panel, where the first path and the second path are mirrored relative to one another and where a first cutting element of the first harp assembly and a second cutting element of the second harp assembly are parallel with one another. Block 360 can include various sub-steps including those outlined in blocks 361-366. Block 361 includes simultaneously actuating the first harp assembly and the second harp assembly in a downward vertical direction along a vertical axis towards the wall panel. Block 362 includes simultaneously actuating the first harp assembly in a first lateral direction along the first path and the second harp assembly in a second lateral direction along the second path, the first lateral direction being opposite from the second lateral direction. Block 363 includes simultaneously actuating the first harp assembly in the first lateral direction and the downward vertical direction along the first path yielding a first half of a first curve and the second harp assembly in the second lateral direction and the downward vertical direction along the second path yielding a first half of a second curve. Block 364 includes simultaneously actuating the first harp assembly in the second lateral direction and the downward vertical direction along the first path yielding a second half of the first curve and the second harp assembly in the second lateral direction and the downward vertical direction along the second path yielding a second half of the second curve. Block 365 includes simultaneously actuating the first harp assembly in the second lateral direction along the first path and the second harp assembly in the first lateral direction along the second path, and block 366 includes simultaneously actuating the first harp assembly and the second harp assembly in an upward vertical direction along the vertical axis and away from the wall panel.

Block 370 includes releasing the wall panel from the vertical alignment clamp assembly, and can include a sub-step such as block 372 which includes actuating the plurality of vertical alignment clamps in the upward vertical direction along the vertical axis such that each respective planar clamp element of the plurality of vertical alignment clamps release the wall panel to release the wall panel. Block 380 includes positioning the horizontal alignment gate in a second upward position. Block 390 includes removing the wall panel from the platform through an exit void left by the horizontal alignment gate.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method, comprising:
receiving, at a control system of a beam cutting system, one or more parameters indicative of a configuration for cutting a wall panel including a first path and a second path;
receiving, at a platform of the beam cutting system, the wall panel, where the wall panel includes a first edge and a second edge defined opposite to the first edge;
aligning, by a horizontal alignment gate of the beam cutting system, the first edge of the wall panel against the horizontal alignment gate such that the wall panel is aligned in a horizontal plane;
immobilizing, by a vertical alignment clamp assembly, the wall panel against the platform;
simultaneously cutting the wall panel along the first path by a first harp assembly forming a first standardized edge having a first horizontal void along the wall panel and along the second path by a second harp assembly forming a second standardized edge having a second horizontal void along the wall panel, wherein the first path and the second path are mirrored relative to one another and wherein a first cutting element of the first harp assembly and a second cutting element of the second harp assembly are parallel with one another;
releasing the wall panel from the vertical alignment clamp assembly;
positioning the horizontal alignment gate in a second upward position; and
removing the wall panel from the platform through an exit void left by the horizontal alignment gate.

2. The method of claim 1, further comprising:
positioning a plurality of vertical alignment clamps of the vertical alignment clamp assembly over the wall panel, each vertical alignment clamp having a planar clamp element and being operable for translation along a vertical axis and along the horizontal plane; and
actuating the plurality of vertical alignment clamps in a downward vertical direction along the vertical axis such that each respective planar clamp element of the plurality of vertical alignment clamps contact a first face of the wall panel.

3. The method of claim 2, further comprising:
actuating the plurality of vertical alignment clamps in an upward vertical direction along the vertical axis such that each respective planar clamp element of the plurality of vertical alignment clamps release the wall panel to release the wall panel.

4. The method of claim 1, further comprising:
simultaneously actuating the first harp assembly and the second harp assembly in a downward vertical direction along a vertical axis towards the wall panel;
simultaneously actuating the first harp assembly in a first lateral direction along the first path and the second harp assembly in a second lateral direction along the second path, the first lateral direction being opposite from the second lateral direction;
simultaneously actuating the first harp assembly in the second lateral direction along the first path and the second harp assembly in the first lateral direction along the second path; and
simultaneously actuating the first harp assembly and the second harp assembly in an upward vertical direction along the vertical axis and away from the wall panel.

5. The method of claim 4, further comprising:
simultaneously actuating the first harp assembly in the first lateral direction and the downward vertical direction along the first path yielding a first half of a first curve and the second harp assembly in the second lateral direction and the downward vertical direction along the second path yielding a first half of a second curve; and
simultaneously actuating the first harp assembly in the second lateral direction and the downward vertical direction along the first path yielding a second half of the first curve and the second harp assembly in the second lateral direction and the downward vertical direction along the second path yielding a second half of the second curve.

6. The method of claim 1, further comprising:
applying a current to a first cutting element of a first harp assembly and a second cutting element of a second harp assembly such that the first cutting element and the second cutting element reach a specified temperature.

7. A beam cutting system, comprising:
a platform configured to receive a wall panel for cutting;
a horizontal alignment gate operable for actuation between a first downward position and a second upward position, wherein the horizontal alignment gate is operable to align the wall panel in a horizontal plane along the platform;
a vertical alignment clamp assembly operable for actuation in a first downward direction along a vertical axis and a second upward direction along the vertical axis;
a first harp assembly having a first cutting element and operable for actuation along a first path, wherein actuation of the first harp along the first path when the wall panel is present along the platform results in a first standardized edge having a first horizontal void along the wall panel;
a second harp assembly having a second cutting element and operable for actuation along a second path, wherein actuation of second first harp along the second path when the wall panel is present along the platform results in a second standardized edge having a second horizontal void along the wall panel and wherein the second cutting element is parallel with the first cutting element; and
a control system including:
a processor in communication with a memory, the memory including instructions, which, when executed, cause the processor to:
receive, at the control system, one or more parameters indicative of a configuration for cutting a wall panel including a first path and a second path, wherein the first path and the second path are mirrored relative to one another;
actuate the horizontal alignment gate to a first downward position for alignment of the wall panel positioned along the platform within the horizontal plane;
actuate the vertical alignment clamp assembly against the wall panel positioned along the platform such that the wall panel is immobilized along the platform by the vertical alignment clamp assembly;
simultaneously actuate the first harp assembly along the first path the second harp assembly along the second path; and
actuate the vertical alignment clamp assembly away from the wall panel positioned along the platform wall panel to release the wall panel.

8. The system of claim 7, wherein the memory of the control system further includes instructions, which, when executed, cause the processor to:
simultaneously actuate the first harp assembly and the second harp assembly in a downward vertical direction along a vertical axis towards the wall panel;
simultaneously actuate the first harp assembly in a first lateral direction along the first path and the second harp assembly in a second lateral direction along the second path, the first lateral direction being opposite from the second lateral direction;
simultaneously actuate the first harp assembly in the second lateral direction along the first path and the second harp assembly in the first lateral direction along the second path; and
simultaneously actuate the first harp assembly and the second harp assembly in an upward vertical direction along the vertical axis and away from the wall panel.

9. The system of claim 8, wherein the memory of the control system further includes instructions, which, when executed, cause the processor to:
simultaneously actuate the first harp assembly in the first lateral direction and the downward vertical direction along the first path yielding a first half of a first curve and the second harp assembly in the second lateral direction and the downward vertical direction along the second path yielding a first half of a second curve; and
simultaneously actuate the first harp assembly in the second lateral direction and the downward vertical direction along the first path yielding a second half of the first curve and the second harp assembly in the second lateral direction and the downward vertical direction along the second path yielding a second half of the second curve.

10. The system of claim 7, wherein the memory of the control system further includes instructions, which, when executed, cause the processor to:
apply, at a first temperature control module, a current to the first cutting element of the first harp assembly such that the first cutting element reaches a specified temperature; and
apply, at a second temperature control module, a current to the second cutting element of the second harp assembly such that the second cutting element reaches a specified temperature.

11. The system of claim 7, wherein the memory of the control system further includes instructions, which, when executed, cause the processor to:
actuate the horizontal alignment gate to the second upward position to open an exit void.

12. The system of claim 7, wherein the memory of the control system further includes instructions, which, when executed, cause the processor to:
actuate the first harp assembly or the second harp assembly in a lateral direction along the platform based on a specified height of the wall panel.
